(19) United States
(12) Patent Application Publication
(10) Pub. No.: US 2011/0049198 A1
(43) Pub. Date: Mar. 3, 2011

(54) ROTARY FEEDERS, ROTOR ASSEMBLIES FOR ROTARY FEEDERS AND RELATED METHODS

(75) Inventor: David J. Muth, Ammon, ID (US)

(73) Assignee: BATTELLE ENERGY ALLIANCE, LLC, Idaho Falls, ID (US)

(21) Appl. No.: 12/548,308

(22) Filed: Aug. 26, 2009

(51) Int. Cl. A01C 15/04; G01F 11/10

(52) U.S. Cl. 222/636; 222/1; 222/368

(57) ABSTRACT

A rotor assembly for a rotary feeder apparatus may include a hollow central shaft, a plurality of circumferentially spaced blades extending generally radially from the hollow central shaft partially forming a plurality of compartments, and at least one valve element associated with an opening formed in a wall of the central shaft. A rotary feeder apparatus may include a housing, a material inlet and outlet, and a rotor assembly. A stationary cam may be disposed within the hollow central shaft of the rotor assembly and a surface of the cam may displace a valve element. Methods of operating a rotary feeder apparatus may include loading a particulate material into a compartment of a rotary feeder, rotating the compartment, supplying a gas to the compartment through an opening in a wall of the hollow central shaft in communication with the compartment, and unloading the particulate material from the compartment.

### STATEMENT REGARDING FEDERALLY SPONSORED RESEARCH OR DEVELOPMENT

This invention was made with government support under Contract No. DE-AC07-05ID14517 awarded by the United States Department of Energy. The government has certain rights in the invention.

### TECHNICAL FIELD

Embodiments of the present invention are directed to a rotary feeder apparatus for use in the supply and discharge of materials in a system and methods of operating a rotary feed apparatus in a system. More particularly, embodiments of the present invention are directed to a rotary feeder apparatus used for the supply and discharge of materials in systems having at least one of a variance in pressure and a variance in gas composition.

### BACKGROUND

Rotary feeders as known in the art are generally used for the supply and discharge of a material. Rotary feeders (otherwise known as rotary airlocks and rotary valve elements) may be used in pneumatic conveying systems, dust control equipment, and as volumetric feeders to maintain an even flow of material through processing systems. Rotary feeders used as volumetric feeders enable metering of materials at precise flow rates from bins, hoppers, or silos into conveying or processing systems. Rotary feeders may also be utilized as an airlock transition point while feeding material into a system. Such rotary feeders may seal pressurized systems against loss of air or other gas while maintaining a flow of material between components of the system with different pressure applications. For example, in alternative fuels processing, materials such as coal, biomass, or the like, may be introduced into a high pressure reactor used to combust and convert the materials into fuel.

Rotary feeders utilized to move materials into a system conventionally include a housing having a generally cylindrical inner wall and end walls at opposite ends thereof to form a cylindrical chamber therein. Generally, rotary feeders also include an upwardly facing material inlet opening and a downwardly facing outlet for conveying material to a desired location. The upwardly facing material inlet receives material from a material holding vessel such as a storage bin for bulk material connected with the housing. The downwardly facing outlet opening is also connected with the housing and discharges material into a receiving area such as a combustion chamber in a gasification process or conveying line. Rotary feeders also include a shaft extending into the end walls of the housing, and a rotor mounted on or formed integrally with the shaft within the housing. A plurality of blades project radially from the rotor to form a plurality of circumferentially spaced compartments around the rotor between the rotor and the housing. The compartments are formed to receive material that is dispensed from the material holding vessel. The material is conveyed through the housing and is discharged through the material outlet. At the material outlet, the material may be unloaded from the rotary feeder into a downstream receiving area.

In applications where the rotary feeder is used to transfer material from a lower pressure area to a higher pressure area, the material inlet receives material from a material holding vessel in communication with the housing in a low pressure area (e.g., atmospheric pressure). In order to provide airtight compartments in the rotary feeder housing between the material inlet and material outlet openings, the end of the blades may pass in close spaced relationship with the inside of the rotary feeder to form a seal with an inner surface of the housing. The blades may also include sealing elements formed on the end of the blades to contact the inner surface of the housing. The material outlet opening discharges material into a higher pressure receiving area. The rotary feeder may move material between the low pressure area and the higher pressure area while attempting to keep the pressurized fluid (e.g., air or another gaseous fluid) in the higher pressure receiving area from flowing from the outlet back toward the inlet to interfere with the feeding of material into the rotary feeder. The rotary feeder may also attempt to minimize the loss of the pressurized fluid from the higher pressure receiving area in order to increase the efficiency of the system.

In processes such as a gasification process that includes the introduction of solids into a high pressure reactor, it may be desirable to move the solids from a low pressure inlet to a high pressure outlet while minimizing the accompanying loss of gas pressure from the reactor. As disclosed in U.S. Pat. No. 5,044,837 to Schmidt, a rotary feeder for transferring particulate material to a high pressure system includes a gas compressor for pressurizing the compartments of the rotary feeder. The compartments of the rotary feeder are pressurized by a compression cylinder through the exterior of the rotary feeder housing as the compartments are rotated from the low pressure area to the high pressure area. The compartments of the rotary feeder are pressurized so that the compartments in the feeder are raised to substantially the same pressure as the pressurized system to which the material is to be transferred. After transfer of the material, a venting opening formed in the housing of the feeder between the material outlet opening and the material inlet opening vents the pressure in each compartment back into the compression cylinder so that it may be refilled with more material.

### BRIEF SUMMARY

In accordance with some embodiments of the present invention, a rotor assembly for a rotary feeder apparatus comprises a central shaft having a plurality of openings formed between an interior and an exterior thereof and a plurality of circumferentially spaced blades extending radially from the central shaft, the plurality of blades defining a like plurality of volumes therebetween. The rotor assembly may also include at least one valve element associated with at least one of the plurality of openings formed in the central shaft.

In additional embodiments, the present invention includes a rotary feeder apparatus including a housing, a material inlet formed on a first side of the housing for receiving material into the housing, and a material outlet formed on a second side of the housing for dispersing material from the housing. A rotor assembly is located within the housing and includes a central shaft and a plurality of circumferentially spaced blades extending radially from the central shaft into a portion of the housing, the plurality of blades defining a plurality of volumes therebetween. In combination with interior surfaces of the housing, the volumes provide compartments for receiving material from the material inlet of the housing and transferring the material to the material outlet thereof. The rotor assembly may also include at least one valve element disposed between at least one of the plurality of compartments and an interior of the central shaft, and at least one cam disposed within the interior of the central shaft. The at least one cam may have a portion positioned to displace the at least one valve element from a first position to a second position as the at least one valve element travels over the portion responsive to rotation of the central shaft, the valve element being biased toward the first position.

In yet additional embodiments, the present invention includes a method of operating a rotary feeder apparatus. The method may include loading a particulate material into a compartment of a rotary feeder at a material inlet of a rotary feeder housing, rotating the compartment from the material inlet of the rotary feeder housing to a material outlet of the rotary feeder housing, supplying a gas to the compartment through at least one valve carried by a rotor, and unloading the particulate material from the compartment at the material outlet of a rotary feeder housing.

### BRIEF DESCRIPTION OF THE SEVERAL VIEWS OF THE DRAWINGS

While the specification concludes with claims particularly pointing out and distinctly claiming that which is regarded as the present invention, advantages of this invention may be more readily ascertained from the following description of the invention when read in conjunction with the accompanying drawings in which:

FIG. 1 is a perspective view of an embodiment of a rotor assembly of the present invention;

FIG. 2 is a plan view of the rotor assembly shown in FIG. 1;

FIG. 3 is an enlarged partial cross-sectional view of a portion of the rotor assembly shown in FIG. 2;

FIG. 3A is an enlarged partial cross-sectional view of a rotor assembly including an additional embodiment of the valve elements and valve covers in accordance with another embodiment of the present invention;

FIG. 3B is an enlarged partial cross-sectional view of a rotor assembly including an additional embodiment of the valve elements and valve covers in accordance with yet another embodiment of the present invention;

FIG. 4 is a partial cross-sectional view of a rotary feeder apparatus in accordance with yet another embodiment of the present invention;

FIG. 5 is a side view of the rotary feeder apparatus shown in FIG. 4;

FIG. 6 is a schematic of an exemplary gasification system including a rotary feeder apparatus in accordance with an embodiment of the present invention.

### DETAILED DESCRIPTION

Illustrations presented herein are not meant to be actual views of any particular assembly apparatus, or system, but are merely idealized representations which are employed to describe embodiments of the present invention. Additionally, elements common between figures may retain the same numerical designation.

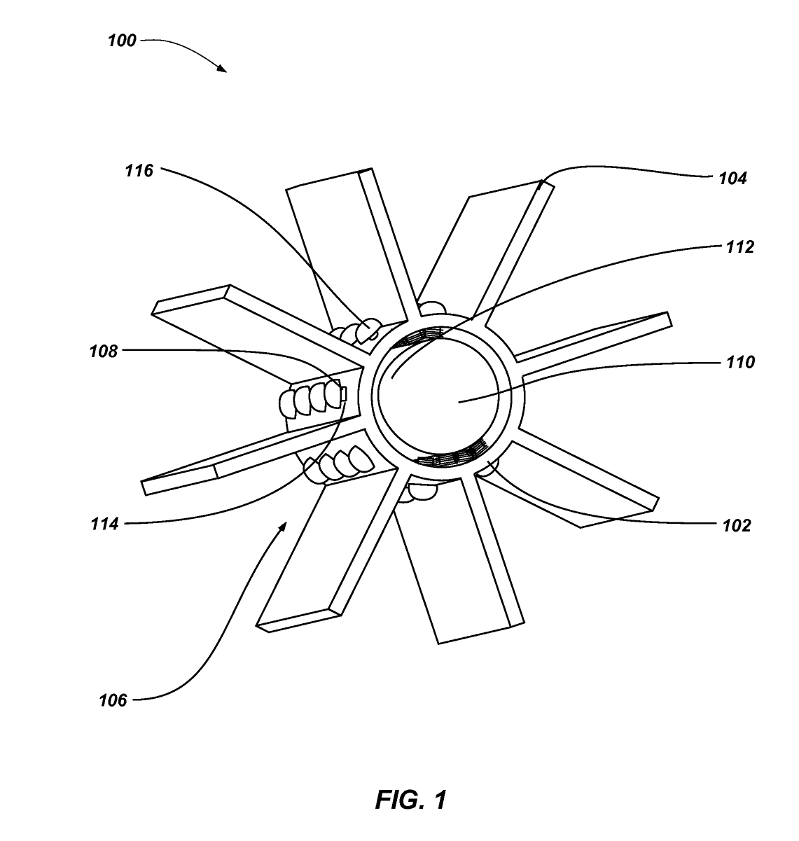

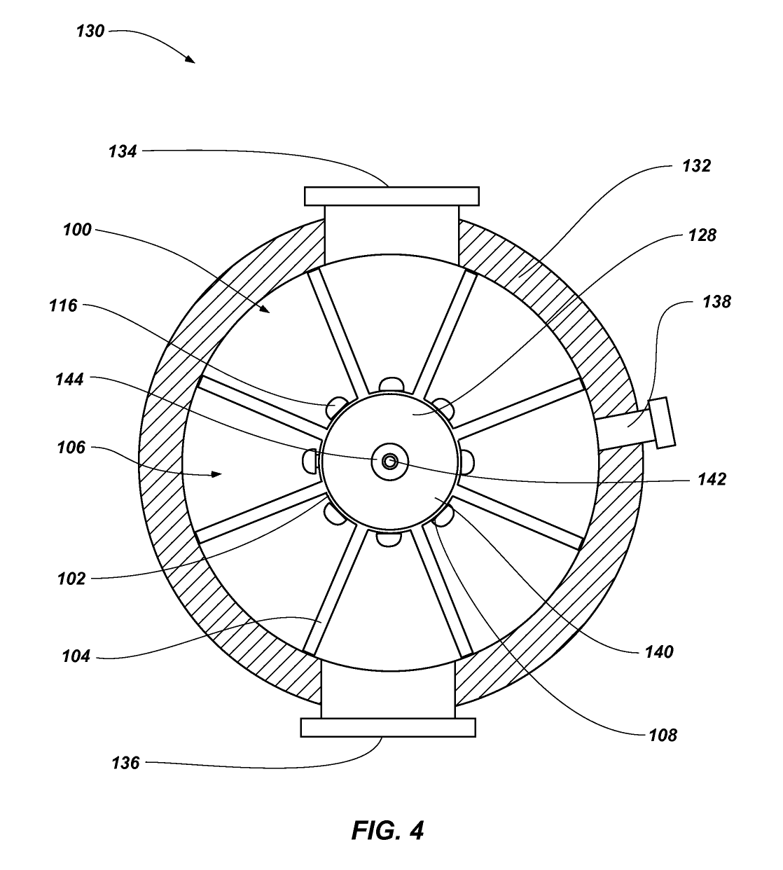

FIG. 1 is a perspective view of an embodiment of a rotor assembly 100 of the present invention. Referring to FIG. 1, the rotor assembly 100 may be used in a rotary feed apparatus 130, discussed below with reference to FIG. 4, to supply and discharge a material or materials. The rotor assembly 100 may include a central shaft 102. In some embodiments, the central shaft 102 may have a substantially tubular shape and may have an inner and an outer surface.

A plurality of blades 104 circumferentially spaced around the central shaft 102 may extend radially from the central shaft 102. The blades 104 may define a portion of a plurality of compartments 106 formed around the central shaft 102 of the rotor assembly 100. For example, two blades 104 proximate to each other may form the lateral sides of one of the compartments 106. In some embodiments, the central shaft 102 may form a portion of the compartments 106 (e.g., the outer surface of the central shaft 102 located adjacent to and extending between the proximal ends of the blades 104). In some embodiments, the blades 104 in unison with another structure (e.g., the housing 132 or the end covers 142 described below with reference to FIG. 4) may form the compartments 106. The compartments 106 may be filled with material and transport the material through a system. For example, the compartments 106 may be filled with material and may rotate about the central shaft 102 to move the material from a first area of a system to a second area of the system. In some embodiments, a plurality of blades 104 (e.g., the eight blades 104 as shown in FIG. 1) circumferentially spaced a distance from each other (e.g., at equidistant intervals around the central shaft 102) may extend from the central shaft 102. The blades 104 and the central shaft 102 may define volumes forming a portion of the compartments 106 (e.g., the eight compartments 106 as shown in FIG. 1) around the central shaft 102. It is noted that while the embodiment shown and described with reference to FIG. 1 illustrates eight blades 104 forming eight compartments 106, the rotor assembly 100 may include any suitable number of blades 104 forming any number of compartments 106.

The rotor assembly 100 may further include valve elements 108 associated with the compartments 106. Each of the compartments 106 of the rotor assembly 100 may have one or more of the valve elements 108 associated therewith. For example, as shown in FIG. 1, the valve elements 108 may be disposed in and extend through openings 114 formed in the wall of the central shaft 102 and to intermittently place the compartments 106 in communication with the hollow interior of the central shaft 102.

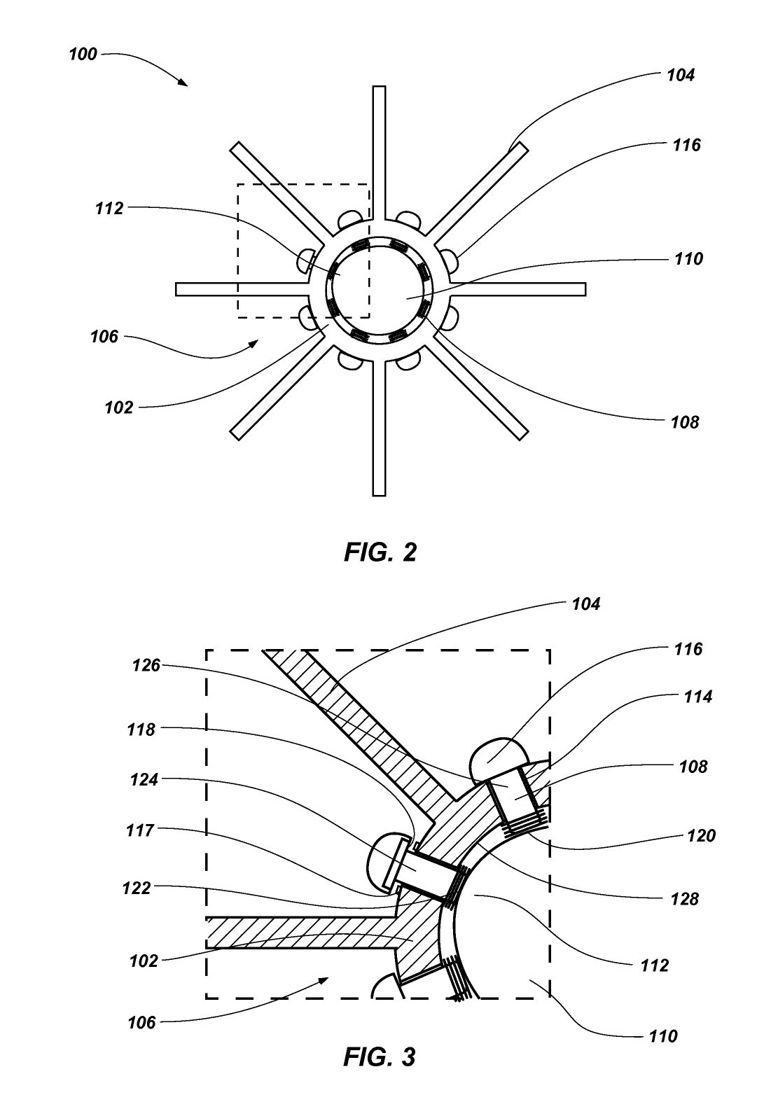

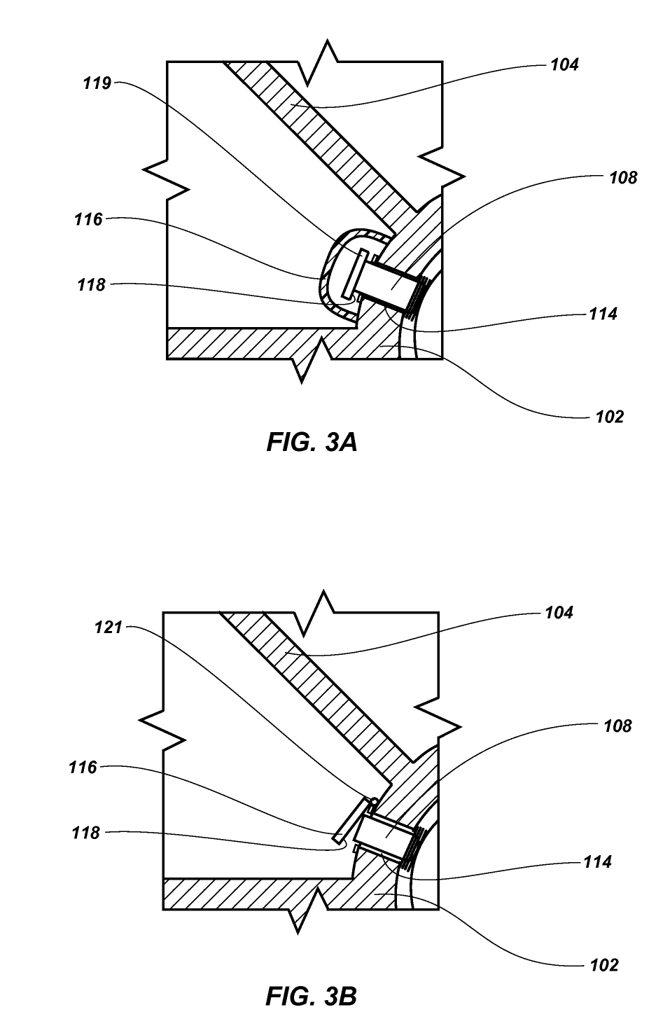

FIG. 2 is a plan view of the rotor assembly shown in FIG. 1 and FIG. 3 is an enlarged partial cross-sectional view of a portion of the rotor assembly shown in FIG. 2. Referring now to both FIGS. 2 and 3, the rotor assembly 100 may include an actuation element configured to displace the valve elements 108 such as, for example, a cam 110 or series of cams 110 disposed within the central shaft 104. Each cam 110 may be centrally disposed within the hollow interior of the central shaft 102 and may have a raised or otherwise eccentric portion 112 positioned to displace the valve elements 108 as the valve elements 108 travel over the raised portion 112 of the cam 110. The cam 110 may be positioned within the central shaft 102 and may be maintained in a static position as the valve elements 108 carried by the central shaft 104 rotate around the cam 110. It is noted that while the embodiment shown and described with reference to FIGS. 2 and 3 illustrates a substantially circular cam 110 having a raised portion 112, the cam 110 may include any other configuration suitable to displace the valve elements 108. For example, the cam 110 may comprise only a raised portion such as a raised ridge positioned in a manner similar to the raised portion 112 in the hollow interior of the central shaft 102.

As the valve elements 108 travel rotationally around a portion of the cam 110 other than the raised portion 112, the valve elements 108 will remain in a closed position relative to the interior of compartments 106, closing off their respectively associated openings 114. In the closed position (e.g., the closed valve position 126, see FIG. 3), each valve element 108 may inhibit a gas or vapor (e.g., pressurized air, steam, water vapor, oxygen, nitrogen, carbon monoxide, carbon dioxide, etc.) from moving from its associated compartment 106 to the hollow interior of the central shaft 104. Similarly, the valve elements 108 in the closed valve position 126 may inhibit a gas or vapor from moving from the hollow interior of the central shaft 104 to their respectively associated compartments 106. As the valve elements 108 travel around the cam 110 near the raised portion 112, the valve elements 108 may begin to displace into an open position (e.g., the open valve position 124, see FIG. 3). For example, as the cam 110 displaces one of the valve elements 108, the valve element 108 is displaced into the open valve position 124 to allow fluid flow through the opening 114 in the central shaft 108. As the valve elements 108 travel over and away from the raised portion of the cam 110, the valve elements 108 return to a closed position. For example, as the valve elements 108 return to the closed valve position 126, a portion of each of the valve elements 108 closes off one of the openings 114 formed in the wall of the central shaft 102 as to not allow fluid flow through the opening 114.

In some embodiments, the rotor assembly 100 may further include valve covers 116 disposed in the interior of the compartments 106. For example, the valve covers 116 may be substantially disposed above the valve elements 108. The valve covers 116 may allow fluid flow to move from the central shaft 104 through the openings 114 past the valve elements 108 when the valve elements 108 are in the open valve position 124. The valve covers 116 may also be sized and configured to impede a solid such as a particulate material disposed in the compartments 106 from inhibiting flow of the fluid from the interior of the central shaft 102 to the compartments 106 via the openings 114. In some embodiments, the valve covers 116 may be disposed on the valve elements 108 and attached thereto. The valve covers 116 may be displaced in unison with the valve elements 108. For example, the valve covers 116 may be integrally formed with the valve elements 108. The valve covers 116 may have a substantially hemispherical shape and may be formed to abut an exterior surface of the central shaft 102 located in the interior of the compartments 106. The valve covers 116 may form a seal around the valve elements 108 which are at least partially disposed through the openings 114 formed in the central shaft 102. As the valve elements 108 are displaced by the cam 110 the valve elements 108 will also displace the valve covers 116 formed thereon. For example, the valve covers 116 may displace from a closed position abutting a surface of the central shaft 102 to an open position and may allow fluid flow through the openings 114 formed in the wall of the central shaft 102. It is noted that while the embodiment shown and described with reference to FIGS. 2 and 3 illustrate the valve covers 116 integrally formed with the valve elements 108, the valve covers 116 may be formed separately from the valve elements 108. For example, the valve covers 116 may be attached to the exterior surface of the central shaft 102 within the compartments 106 and may substantially surround and enclose a portion of an associated valve element 108. In some embodiments, for example the embodiment of FIG. 3A described hereinbelow, the valve covers 116 may comprise a permeable material formed over the valve elements 108 in the compartments 106. Such a permeable material may include, without limitation, a screen or a permeable polymer membrane.

The valve elements 108 may further include a sealing surface 118 and a follower surface 120. The sealing surface 118 may be disposed proximate to a first end of one or more of the valve elements 108. When the valve elements 108 are in a closed valve position 126, the sealing surfaces 118 may abut with a surface such as an interior surface of the compartments 106 (e.g., an exterior surface of the central shaft 102 surrounding one of the openings 114 formed therein). The sealing surface 118 may substantially separate a gas or vapor in the compartments 106 from a gas or vapor within the central shaft 102. For example, the sealing surface 118 may inhibit a gas from moving from the hollow interior of the central shaft 102 to the compartments 106 and may inhibit a gas from moving from the compartments 106 to the hollow interior of the central shaft 102. In some embodiments, the sealing surface 118 may include additional elements to secure a seal around an opening 114 through the wall of the central shaft 102 such as an O-ring or gasket formed on or secured to the valve elements 108 to partially form the sealing surface 118. For example, the sealing surface 118 may include a suitable material to create a substantially gas-tight seal with the exterior surface of the central shaft 102 such as, for example, fiber, paper, rubber, silicone, metal, cork, felt, neoprene, rubber, fiberglass, polymers, etc. In some embodiments, the O-ring 117 may be secured to the exterior surface of the central shaft 102.

It is noted that while the embodiment shown and described with reference to FIGS. 2 and 3 illustrates the sealing surface 118 abutting with the outer surface of the central shaft 102, the sealing surface 118 may be received within a depression formed in the exterior surface of the central shaft 102. It is also contemplated that a valve seat (not shown) may be provided on the exterior surface of the central shaft 102, including within the aforementioned depression, in order to facilitate a better seal. As depicted in FIG. 3, the sealing surface 118 may be carried on a valve cover 116 or, alternatively and as shown in FIG. 3A, the sealing surface 118 may be carried on a flange 119 on the end of a valve element 108 while valve cover 116 remains stationary, secured to the exterior surface of the central shaft 102 and is of sufficient height to accommodate displacement of flange 119 thereinto as valve element 108 moves to permit fluid flow through the associated opening 114. It is further contemplated that, as depicted in FIG. 3B, the sealing surface 118 may be carried on a hinged valve cover 116. For example, the sealing surface 118 may be carried on a valve cover 116 that is secured to the exterior surface of the central shaft 102 by a spring-biased hinge 121. The hinge 121 may bias the valve cover 116 in a closed position abutting the exterior surface of the central shaft 102. The valve element 108 may displace the flange 119 to permit fluid flow through the associated opening 114.

The valve elements 108 may also include a follower surface 120 disposed at a second end of the valve elements 108 opposite to the first end of the valve elements 108. The follower surface 120 may be positioned within the central shaft 102 to abut with the cam 110. For example, as the follower surface 120 of one or more of the valve elements 108 travels around a portion of the cam 110 away from the raised portion 112, the valve 108 will remain in a closed valve position 126 relative to the interior of the compartments 106 As the follower surface 120 of the valve element 108 travels around the cam 110 near the raised portion 112, the raised portion 112 will displace the follower surface 120 toward the wall of the central shaft 102 and the valve element 108 may begin to displace into an open valve position 124. As the follower surface 120 of the valve 108 travels over and away from the raised portion 112 of the cam 110, the raised portion 112 will no longer displace the follower surface 120 toward the wall of the central shaft 102 and the valve element 108 may return to the closed position. It is noted that while the embodiment shown and described with reference to FIGS. 2 and 3 illustrates each of the valve elements 108 having a follower surface 120 abutting with the cam 110 as the valve elements 108 rotate around the cam 110, in some embodiments, the follower surface 120 may only abut with the raised portion 112 of the cam 110 as the valve elements 108 are rotated in a position proximate to the raised portion 112.

In some embodiments, the valve elements 108 may include a biasing feature such as a spring 122. The spring 122 may be disposed between the interior surface of the wall of the central shaft 102 and the follower surface 120 of an associated valve element 108. One end of the spring 122 is positioned to act on the wall of the central shaft 102, while the other end is secured to valve element 108 by, for example, a bolt, clip or other fastener, by the other end being received within an aperture in the spring 122, or a combination thereof. The spring 122 may act to bias of the associated valve element 108 in a predetermined position. For example, the spring 122 may bias one of the valve elements 108 into a closed valve position 126 while the valve element 108 is not in contact with the raised portion 112 of the cam 110. As the valve element 108 biased by the spring 122 is rotated into contact with the raised portion 112 of the cam 110, the spring 122 will compress and the valve element 108 will move to the open valve position 124. As the valve element 108 biased by the spring 122 is rotated away from and out of contact with the raised portion 112 of the cam 110, the spring 122 will uncompress and return the valve element 108 to the closed position.

FIG. 4 is a partial cross-sectional view of a rotary feeder apparatus 130 in accordance with an embodiment of the present invention. As shown in FIG. 4, the rotary feeder apparatus 130 may include a housing 132, a material inlet 134, a material outlet 136, and a rotor assembly 100 similar to the rotor assembly 100 shown and described with reference to FIGS. 1, 2, and 3. The material inlet 134 may comprise a passageway formed through the housing 132 of the rotary feeder apparatus 130 at a location such as, for example, in a first side of the housing 132, shown at the top of housing 132 in FIG. 4. The material inlet 134 may be used to receive material into the housing 132. For example, an upstream device suitable for holding materials, loading materials, or both holding and loading materials into the rotary feeder apparatus 130 (e.g., a bin, a hopper, a conveyor, an auger, etc.) may be disposed near the material inlet 134. The upstream device may deliver material to the compartments 106 formed by the rotor assembly 100 of the rotary feeder apparatus 130 though the material inlet 134.

The material outlet 136 may comprise a passageway formed through the housing 132 of the rotary feeder apparatus 130 at a location such as in a second side of the ‘housing 132, shown at the bottom of the housing 132 in FIG. 4. The material outlet 136 may be configured to receive the material from the housing 132. For example, a downstream device such as a bin, a hopper, a conveyor, an auger, etc. may receive the material as it is unloaded from the compartments 106 formed by the rotor assembly 100 through the material outlet 136 formed in the rotary feeder apparatus 130. It is noted that while the embodiment shown and described with reference to FIG. 4 illustrates a material inlet and outlet 134, 136 located on an upper and lower portion, respectively, of the housing 132 of the rotary feeder apparatus 130, the material inlet and material outlet may be located at any suitable location of the rotary feeder apparatus 130. For example, the material inlet may be located in a side portion of the housing 132 (e.g., a wall of the housing 132 perpendicular to the blades 104 of the rotor assembly 100).

As shown in FIG. 4, the compartments 106 in unison with the housing 132 may be filled with material though the material inlet 134 and may rotationally transport the material to the material outlet 136. In some embodiments, the blades 104 may abut inner surfaces of the outer wall and the side walls of the housing 132 to create substantially air-tight compartments 106. As the compartments 106 rotate from the material inlet 134 to the material outlet 136, a gas composition of the compartments 106, a pressure of the compartments 106, or both the gas composition and pressure of the compartments 106 may be altered. For example, as the compartments 106 rotate from the material inlet 134 to the material outlet 136, the compartments 106 may be pressurized by a gas entering into the compartments 106 from the interior of the central shaft 102. In some embodiments, the compartments 106 may be pressurized to substantially match the pressure of the system at the material outlet 136 of the rotary feeder apparatus 130.

In some embodiments, the central portion of the central shaft 106 may form a chamber 128 such as, for example, a pressurized gas chamber. The hollow interior of the central shaft 102 may be sealed to form the chamber 128. For example, the chamber 128 may be sealed at either axial end of the rotor assembly 100 by end covers 140. It is noted that while the embodiment shown and described with reference to FIG. 4 illustrates end covers 140 having a size similar to that of the central shaft 102, the chamber 128 may be sealed by other configurations. For example, in some embodiments, the chamber 128 may be sealed by the outer walls of the housing 132. In some embodiments, the end covers 140 may be formed to have a size similar to the rotor assembly 100. For example, the end covers 140 may cover the chamber 128 and extend radially and circumferentially along the blades 104 to form sides of the compartments 106. In some embodiments, the chamber 128 may have a width greater than the width of the rotor assembly 100 (i.e., the chamber 128 has a dimension measured along the rotational axis of the rotor assembly 100 greater than a similarly measured dimension of the central shaft 102 of the rotor assembly 100).

When the compartments 106 reach the material outlet 136 formed in the housing 132 of the rotary feeder apparatus 130, the material in the compartments 106 may be unloaded. In some embodiments, the compartments 106 may be pressurized by gas from the chamber 128 to have a pressure greater than the pressure at a downstream area of the system. The greater pressure in the compartments 106 may act to facilitate quicker unloading of the material within the compartments 106 as contents of the higher pressure compartments 106 will tend to move into lower pressure of the downstream system.

After unloading the material, the compartments 106 may be rotated back to the material inlet 134 to be loaded with material again. In some embodiments, as each of the compartments 106 rotate from the material outlet 136 to the material inlet 134, a portion of the gas supplied to the compartments 106 may be released. For example, as each of the compartments 106 rotates from the material outlet 136 to the material inlet 134, the compartments 106 may pass a relief valve formed in the housing 132. The relief valve 138 may be an opening such as steel mesh formed in the side the housing 132 and may be placed in fluid connection with a downstream portion of a system to reduce energy loss due to the release of the gas supplied to the compartments 106. For example, the compartments 106 may be pressurized by gases to be substantially equal with a pressure in a downstream area of the system. When each of the compartments 106 is rotated to a position in proximity to the material outlet 136, the material will be at a desired pressure to the match the area into which the material is loaded. After unloading the material, the compartments 106 may continue to rotate back toward the material inlet 134 which may be at a lower pressure relative to the pressure of the downstream area. The gas released from the empty compartments 106 through the relief valve may be captured and recycled. For example, the gas may be released through the relief valve 138 and may be captured and recycled back into the chamber 128 or to a source of pressurized fluid (see below) to increase the efficiency of the system.

In some embodiments, the pressure in the chamber 128 may be significantly higher than the pressure at the material inlet 134. For example, the pressure at the material inlet 134 may be at a first pressure and the pressure in the system downstream from the rotary feeder apparatus 130 may be a second pressure higher than the first pressure. The higher second pressure in the chamber 128 may inhibit the material in the compartments 106 from blocking the valve elements 108 or openings 114. For example, the opening of the valve elements 108 may release the higher pressure gas from the chamber 128 into the compartments 106 and the flow of the gas from the higher pressure area to the lower pressure area may inhibit the material in the compartments 106 from traveling from the lower pressure area to the higher pressure area through the openings 114.

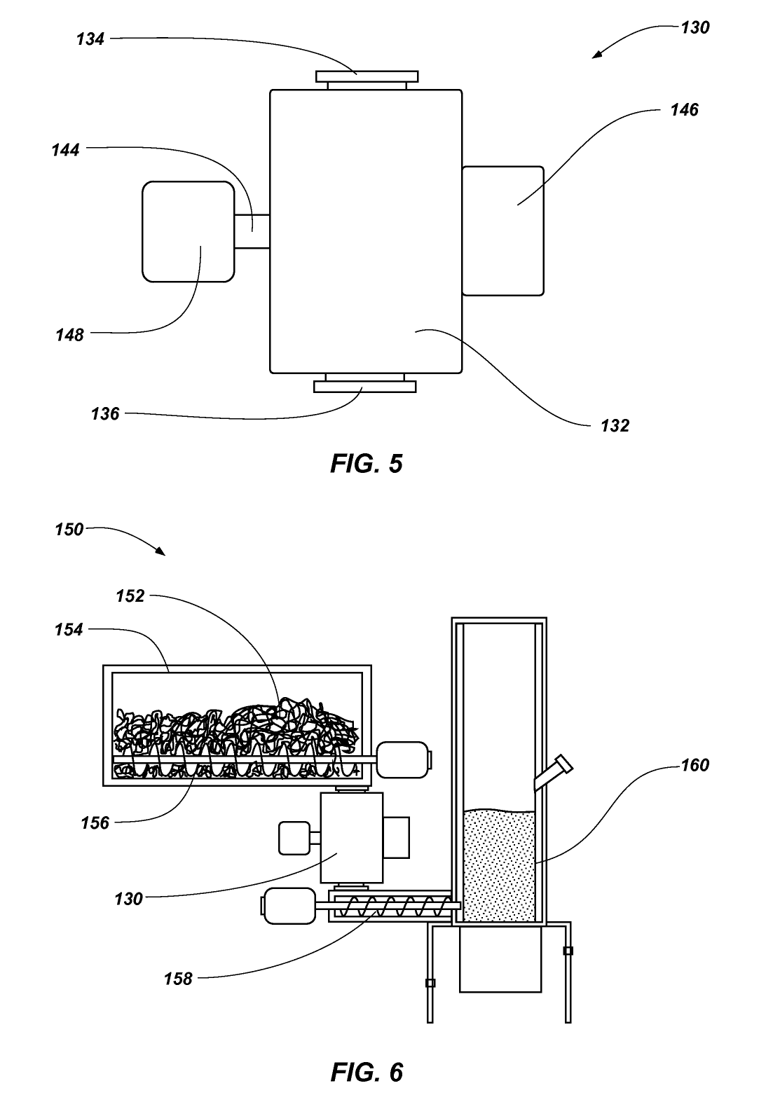

The rotary feeder apparatus 130 may further include a rotational drive feature configured to turn the rotary feeder apparatus 130 such as, for example, a rotational drive shaft 144. The rotational drive shaft 144 may be coupled to a portion of the rotor assembly 100 (e.g., at the end covers 140). The rotational drive shaft 144 may be connected to a motor 146 (FIG. 5) and used to turn the rotor assembly 100 within the housing 132 of the rotary feeder apparatus 130. For example, the rotational drive shaft 144 may be coupled to the end covers 140 of the rotor assembly 100 and rotation of the drive shaft 144 may rotate the rotor assembly 100 within the housing 132. In some embodiments, the rotational drive shaft 144 may be rotated around a cam shaft 142 disposed in a hollow interior of the rotational drive shaft 144. The cam shaft 142 may be coupled to the cam 110 (FIG. 3) and may extend through the end covers 140 of the rotor assembly 100. The cam shaft 142 may hold the cam 110 (FIG. 2) disposed in the central shaft 102 of the rotor assembly 100 in a stationary position while rotational drive shaft 144 rotates the rotary feeder apparatus 130 around the cam 110.

FIG. 5 is a side view of the rotary feeder apparatus shown in FIG. 4. As shown in FIG. 5, the rotary feeder apparatus 130 may include a motor 146 and a pump 148. For example, the motor 146 may by coupled to the rotational drive shaft 144 and may turn the rotary feeder apparatus 130 within the housing 132 of the rotary feeder apparatus 130. A source of pressurized fluid, such as a gas, in the form of pump 148 may also be in fluid communication with the rotary feeder apparatus 130. For example, the pump 148 may be connected to the chamber 128 located within the central shaft 102. The pump 148 may provide pressurized gas, gas composition (e.g., a specific formulation of oxygen, nitrogen, carbon monoxide, carbon dioxide, etc.), or a combination thereof, to the chamber 128. In some embodiments, the pump 148 may be used to increase the pressure of the gas in the chamber 128. In some embodiments, the pump 148 may be coupled directly to the housing 132. In some embodiments, the pump 148 may be separate from the housing 132 of the rotary feeder apparatus 130 and may be in fluid connection with the chamber 128 through a connector such as a rotating union.

FIG. 6 is a schematic of an embodiment of a system such as, for example, a gasification system 150 including a rotary feeder apparatus 130 in accordance with an embodiment of the present invention. By the way of example and not limitation, a rotary feeder apparatus 130 may be utilized in a system such as a gasification system. The gasification system 150 may be utilized, for example, to produce a fuel from organic materials. Materials such as biomass 152 may be loaded into a storage bin such as a hopper 154. The hopper 154 may include an auger 156 located in the bottom of the hopper 154 to feed biomass into the rotary feeder apparatus 130. As discussed above, the rotary feeder apparatus 130 may be used to transport the biomass from an upstream location if the system 150 (e.g., the hopper 154) to a downstream location of the system 150 (e.g., the injection auger 158). As discussed above in reference to FIGS. 1 through 4, the rotor assembly 100 may rotate the compartments 106 from the material inlet 134 to the material outlet 136 while valve elements 108 in the compartments 106 supply a gas to the compartments 106 and the biomass 152 contained therein.

The rotary feeder apparatus 130 may pressurize the compartments 106 of the rotary feeder apparatus 130, may control the gas composition contained in the compartments 106, or may both pressurize and control the gas composition of the compartments 106 as the biomass 152 is transported from the material inlet 134 to the material outlet 136 of the rotary feeder apparatus 130. In some embodiments, the compartments 106 and biomass 152 contained therein may be treated by the rotary feeder apparatus 130 to have a pressure, gas composition, or both a pressure and gas composition similar to the pressure, gas composition, or both a pressure and gas composition of the downstream portion of the gasification system 150. For example, the pressure of the compartments 106 at the material inlet 134 may be at a first pressure (e.g., atmospheric pressure measuring approximately 14.73 psi (101.56 kPa)). The rotary feeder apparatus 130 may be used to pressurize the compartments 106 to a second pressure (e.g., 600 to 1500 psi (approximately 4.137 mPa to 10.342 mPa)). As discussed above, in some embodiments, the compartments 106 may be pressurized to have substantially the same pressure as the downstream system into which the material is unloaded through the material outlet 136. In some embodiments, the compartments 106 may be pressurized to have a pressure greater than or less than that of the downstream system.

In some embodiments, the rotary feeder apparatus 130 may be used to alter the gas makeup of the compartments 106 from a first gas composition to a second gas composition. For example, the compartments 106 at the material inlet 134 may have a first gas composition such as, for example, an atmospheric gas composition (e.g., air). The rotary feeder apparatus 130 may add additional gas (e.g., oxygen, nitrogen, etc.) to the first gas composition to form a second gas composition in the compartments 106.

When the compartments 106 including the biomass 152 reach the material outlet 136 of the rotary feeder apparatus 130, the biomass 152 in the compartments 106 may be unloaded into the injection auger 158. The injection auger 158 may be used to transport the biomass 152 to a reactor such as a fluidized bed reactor 160 where the biomass 152 may be mixed with oxygen, steam, air, or a combination thereof and combusted to produce a fuel from the biomass 152.

The rotary feeder apparatus 130 may be sized and configured to deliver a set amount of material into a system (e.g., the gasification system 150 described above with reference to FIG. 6). By the way of example and not limitation, the rotary feeder apparatus 130 may be sized, for example, to deliver 800,000 tons/year (approximately 2,200 tons/day) of biomass into the gasification system 150. Referring to FIG. 4, the rotary feeder apparatus 130 may have a housing having an outer diameter of 4 feet (approximately 1.219 meters). The chamber 128 may have a diameter of 1 foot (approximately 0.305 meters). The housing 132 may have a width (i.e., a dimension measured along a rotational axis of the central shaft 102) of 1 foot (approximately 0.305 meters). The rotor assembly 100 may be driven to turn at a rate of ten rotations per minute. The rotary feeder apparatus 130 may be used to pressurize the compartments 106 from a first atmospheric pressure of approximately 14.73 psi (101.56 kPa) to a second pressure of approximately 1000 psi (6.895 mPa). Such a system using the rotor assembly 100 may pressurize each of the compartments 106 in about 2 seconds as the valve elements 108 in communication with the compartments 106 pass over the cam 110. Similarly, the compartments 106 may be depressurized in about 2 seconds as each of the compartments 106 passes the relief valve 138.

Referring to FIGS. 3 and 4, a method of operating a rotary feeder apparatus 130 is discussed. A method of operating a rotary feeder apparatus 130 may include loading a particulate material into a compartment (e.g., one of the compartments 106) of a rotor assembly 100 at a first side (e.g., a material inlet 134) of a rotary feeder housing 132 and rotating the compartment 106 from the first side of the rotary feeder housing 132 to a second side (e.g., a material outlet 136) of the rotary feeder housing 132. The method may also include supplying a gas to the compartment 106 through a valve (e.g., one of the valve elements 108) formed in the rotor assembly 100, and unloading the particulate material from the compartment 106 at the material outlet 136 of a rotary feeder housing 132.

In some embodiments, the method may include rotating the compartment 106 from the material outlet 136 of the rotary feeder housing 132 to the material inlet 134 of the rotary feeder housing 132 and releasing a portion of the gas from the compartment 106 through an opening (e.g., the relief valve 138) formed in the rotary feeder housing 132. In some embodiments, the valve elements 108 may be opened by a cam 110 disposed within a central shaft 102 of the rotor assembly 100.

The method may include supplying the gas to increase the pressure in the compartment 106 through the openings 114 formed in the rotor assembly 100 as their associated valve elements 108 are respectively moved. In some embodiments, the gas may be supplied to the compartment 106 while rotating the compartment 106 from the material inlet 134 of the rotary feeder housing 132 to the material outlet 136 of the rotary feeder housing 132.

The method may also include releasing a portion of the gas from the compartment 106 through the relief valve 138 formed in the rotary feeder housing 132 to decrease the pressure in the compartment 106. In some embodiments, the gas may be released through the through the relief valve 138 while rotating the compartment 106 from the material outlet 136 of the rotary feeder housing 132 to the material inlet 134 of the rotary feeder housing 132.

In view of the above, embodiments of the present invention may be particularly useful in providing a rotary feeder apparatus where material is to be moved from a first area having a first pressure, gas composition, or a combination thereof to a second area having a second pressure, gas composition, or a combination thereof. The rotary feeder apparatus may provide a gas transition within the rotary feeder apparatus and may recapture the gas supplied to the rotary feeder apparatus to improve the efficiency of the system and minimize gas and pressure losses. By minimizing the losses associated with the pressurize and gas composition differentials, the rotary feeder apparatus may be fully scalable as to allow large systems to operate over large pressure and gas composition differentials while minimizing the losses due to the differentials in such systems. The rotary feeder apparatus may also enhance gasification systems using biomass by allowing for the high pressure differentials necessary to transport biomass into a high pressure gasification system such as a gasification system including a fluidized bed reactor while decreasing the losses of gas and pressure as compared to similar, but conventional, gasification systems.

While the invention is susceptible to various modifications, as well as alternative forms and implementations, specific embodiments have been shown by way of example in the drawings and have been described in detail herein. However, the invention is not intended to be limited to the particular forms and embodiments disclosed. Rather, the invention, in various embodiments, covers all modifications, equivalents, and alternatives falling within the scope of the invention as defined by the following appended claims and their legal equivalents.

What is claimed is:

1. A rotor assembly for a rotary feeder apparatus comprising:
a hollow central shaft having a plurality of openings formed through a wall thereof;
a plurality of circumferentially spaced blades extending generally radially from the wall of the hollow central shaft, the plurality of blades and an exterior surface of the hollow central shaft wall at least partially forming a plurality of compartments, at least one of the plurality of openings extending between an interior of the hollow central shaft and each compartment of the plurality; and
at least one valve element associated with at least one of the plurality of openings formed in the central shaft.

2. The rotor assembly of claim 1, further comprising an at least one actuation feature disposed within the hollow central shaft, the at least one actuation feature positioned to displace the at least one valve element to an open position permitting communication through an associated opening as the at least one valve element contacts a portion of the actuation feature.

3. The rotor assembly of claim 1, further comprising at least one cam, the at least one cam disposed within the hollow central shaft and having a raised portion positioned to displace the at least one valve element to an open position permitting communication through an associated opening as the at least one valve element contacts the raised portion of the at least one cam.

4. The rotor assembly of claim 3, wherein the at least one valve element comprises:
a follower surface disposed at an end of the at least one valve, the follower surface positioned to contact the raised portion of the cam and move the valve element to the open position; and
a spring disposed between the follower surface and a portion of an inner surface of the hollow central shaft wall, the spring positioned to bias the at least one valve toward a closed position.

5. The rotor assembly of claim 4, wherein the at least one valve element further comprises a sealing surface disposed proximate to an end of the at least one valve element opposing the follower surface, the sealing surface abutting with a portion of an outer surface of the wall of the hollow central shaft and occluding at least one of the plurality openings when the at least one valve is in the closed position.

6. The rotor assembly of claim 1, wherein at least one valve element comprises a plurality of valve elements, at least one of the plurality of valve elements located in each of the plurality of compartments, and wherein each of the plurality of valve elements is associated with one of the plurality of openings formed in the wall of the hollow central shaft.

7. The rotor assembly of claim 1, wherein the hollow central shaft forms a chamber, the chamber being in selective fluid communication with each of the plurality of compartments through the plurality of openings formed in the wall of the central shaft.

8. The rotor assembly of claim 9, further comprising at least two end plates coupled to the central shaft at axially spaced positions to form the chamber and wherein the chamber is configured to hold a pressurized gas.

9. A rotary feeder apparatus comprising:
a housing;
a material inlet formed on a first side of the housing for receiving material into the housing;
a material outlet formed on a second side of the housing for dispersing material from the housing; and
a rotor assembly located within the housing, the rotor assembly comprising:
a rotatable central shaft having a chamber formed therein;
a plurality of circumferentially spaced blades extending generally radially outwardly from the central shaft, the plurality of blades and an exterior surface of the central shaft forming, in conjunction with interior surfaces of the housing, a plurality of compartments for receiving material from the material inlet of the housing;
at least one valve element associated with an opening in fluid communication with the chamber formed in the central shaft and at least one compartment of the plurality; and
at least one stationary cam disposed within the central shaft, the at least one cam having a raised portion positioned to displace the at least one valve element responsive to contact of the at least one valve element with the raised portion of the cam.

10. The rotary feeder apparatus of claim 9, further comprising:
a motor;
a rotational drive shaft assembly coupled to a portion of the rotor assembly and to the motor, for rotating the rotor assembly around the cam; and
a cam shaft disposed within a hollow interior of the rotational drive shaft, wherein the cam shaft holds the cam stationary.

11. The rotary feeder apparatus of claim 9, wherein the chamber is formed by at least a portion of the central shaft and by at least one of a portion of the housing and a portion of at least one end cap.

12. The rotary feeder apparatus of claim 9, further comprising a source of pressurized gas in fluid connection with the chamber.

13. The rotary feeder apparatus of claim 12, wherein the housing comprises a relief valve between an interior and an exterior of the housing, the relief valve positioned between the material inlet and the material out and wherein the relief valve is in fluid connection with at least one of the chamber and the source of pressurized gas.

14. A method of operating a rotary feeder apparatus, the method comprising:
loading a material into a compartment of a rotor assembly at a material inlet of a rotary feeder housing;
rotating the compartment from the material inlet of the rotary feeder housing to a material outlet of the rotary feeder housing;
supplying a gas to the compartment by opening at least one valve element associated with an opening formed in the rotor assembly; and
unloading the particulate material from the compartment at the material outlet of the rotary feeder housing.

15. The method of claim 14, further comprising:
rotating the compartment from the material outlet of the rotary feeder housing to the material inlet of the rotary feeder housing; and
releasing a portion of the gas from the compartment through an opening formed between an interior and an exterior of the rotary feeder housing before the compartment reaches the material inlet.

16. The method of claim 14, further comprising opening the at least one valve element with a cam disposed within a central shaft of the rotor assembly.

17. The method of claim 15, wherein supplying a gas to the compartment by opening at least one valve element associated with an opening formed in the rotor assembly comprises supplying the gas to increase the pressure in the compartment through the opening.

18. The method of claim 17, wherein releasing a portion of the gas from the compartment through an opening formed between an interior and an exterior of the rotary feeder housing before the compartment reaches the material inlet comprises releasing the portion of the gas to decrease the pressure in the compartment.

19. The method of claim 15, wherein supplying a gas to the compartment by opening at least one valve element associated with an opening formed in the rotor assembly comprises supplying the gas to the compartment through the opening while rotating the compartment from the material inlet of the rotary feeder housing to the material outlet of the rotary feeder housing.

20. The method of claim 19, wherein releasing a portion of the gas from the compartment through an opening formed between an interior and an exterior of the rotary feeder housing before the compartment reaches the material inlet comprises releasing the portion of the gas from the compartment through the opening formed between the interior and the exterior of the rotary feeder housing while rotating the compartment from the material outlet of the rotary feeder housing to the material inlet of the rotary feeder housing.
